(19) United States
(12) Patent Application Publication
(10) Pub. No.: US 2026/0274185 A1
(43) Pub. Date: Sep. 17, 2026

(54) VEHICLE BATTERY PACK

(71) Applicants: Hyundai Motor Company, Seoul (KR); Kia Corporation, Seoul (KR)

(72) Inventors: Jun Ho SUH, Hwaseong-Si (KR); June Ho LEE, Hwaseong-Si (KR); Yoon Hyuk KANG, Hwaseong-Si (KR); Hyun Woo YOON, Hwaseong-Si (KR)

(73) Assignees: Hyundai Motor Company, Seoul (KR); Kia Corporation, Seoul (KR)

(21) Appl. No.: 19/291,452

(22) Filed: Aug. 5, 2025

(30) Foreign Application Priority Data
Mar. 13, 2025 (KR) 10-2025-0032902

(51) Int. Cl. B60R 16/04; H01M 10/613; H01M 10/625; H01M 10/6554; H01M 10/656; H01M 50/204; H01M 50/242; H01M 50/249

(52) U.S. Cl. CPC B60R 16/04; H01M 10/613; H01M 10/625; H01M 10/6554; H01M 10/656; H01M 50/204; H01M 50/242; H01M 50/249; H01M 2220/20

(57) ABSTRACT

A vehicle battery pack is configured to improve vehicle performance by disposing, in the vehicle battery pack, a cross member disposed on the upper portion of the vehicle floor and coupled to a vehicle seat and directly coupling the vehicle seat to the cross member disposed in the battery pack.

### CROSS-REFERENCE TO THE RELATED APPLICATION

This application claims priority from Korean Patent Application No. 10-2025-0032902, filed on Mar. 13, 2025, in the Korean Intellectual Property Office, the disclosure of which is incorporated herein by reference in its entirety.

### BACKGROUND OF THE DISCLOSURE

### Field of the Disclosure

The present disclosure relates to a vehicle battery pack configured to dispose, in the vehicle battery pack, a cross member disposed on the upper portion of the vehicle floor and coupled to a vehicle seat, and to directly couple the vehicle seat to the cross member disposed in the vehicle battery pack, thereby improving space utilization and collision performance of a vehicle.

### Description of the Related Art

Research and development has been actively conducted on vehicles to improve human mobility. With constantly evolving technology, current vehicles serve not only as a transportation means but also as a space for convenience. Therefore, vehicles are required to be designed in consideration of comprehensive factors such as securing rigidity and strength for safety of passengers, improving fuel and energy efficiency, and reducing noise and vibration to secure user convenience.

In vehicles of the related art, structural rigidity is reinforced by disposing a seat cross member on the upper portion of the vehicle floor in the traverse direction of the vehicle, and a vehicle seat is coupled to the seat cross member. For example, since the vehicle seat is disposed above the seat cross member, additional space needs to be provided corresponding to the height of the seat cross member installed on the vehicle floor. As a result, the total weight of the vehicle is increased by the weight of the seat cross member.

Such an increase in the overall height and total weight of the vehicle causes deterioration in efficiency and convenience of the vehicle. Therefore, there has been a demand for technology through which the overall height and weight of a vehicle is reduced while a seat cross member constantly serves to reinforce structural rigidity of the vehicle.

The information disclosed in this Background of the Disclosure section is only for enhancement of understanding of the general background of the disclosure, and should not be taken as an acknowledgement or any form of suggestion that this information forms the prior art already known to a person skilled in the art.

### SUMMARY

Therefore, the present disclosure has been made in view of the above problems, and it is an object of the present disclosure to provide a vehicle battery pack configured to dispose, in the vehicle battery pack, a cross member disposed on the upper portion of the vehicle floor and coupled to a vehicle seat, and to directly couple the vehicle seat to the cross member disposed in the vehicle battery pack, thereby improving space utilization and collision performance of a vehicle.

The objects of the present disclosure are not limited to the above-mentioned objects, and other technical objects not mentioned herein will be clearly understood by those skilled in the art to which the present disclosure pertains from the detailed description of the embodiments.

In accordance with the present disclosure, the above and other objects may be accomplished by the provision of a vehicle battery pack including a battery case coupled to a lower portion of a vehicle floor, the battery case including a plurality of battery units disposed therein, and a cross member disposed in the battery case and traversing the battery case, the cross member being disposed between the plurality of battery units, the cross member including a lower end portion coupled to a lower end portion of the battery case and an upper end portion formed to extend to an upper end portion of the battery case, the cross member being directly coupled to a seat disposed in an internal space of a vehicle by penetrating the vehicle floor.

The cross member may be disposed in a transverse direction of the vehicle inside the battery case.

The cross member may include an upper center portion directly coupled to the seat with the vehicle floor interposed therebetween.

The cross member may include a protrusion protruding upwards from an upper center portion thereof, and the protrusion may be directly coupled to the seat with the vehicle floor interposed therebetween.

The cross member may include a fixing portion formed at an upper side portion thereof, the fixing portion being formed lower than the protrusion, and the battery unit may be fixed to the fixing portion.

The battery case may include a battery member disposed therein, the battery member including a mounting portion configured to fix the battery unit, and a height of the mounting portion may be equal to a height of the fixing portion.

The cross member may include a nut disposed in an upper portion thereof, the nut may be coupled to a first end portion of a coupling portion, and a second end portion of the coupling portion may penetrate the vehicle floor to be coupled to the seat.

The coupling portion may extend from a lower portion of the seat and may penetrate the vehicle floor to be coupled to the nut.

The battery case may include an upper surface sealed by a battery cover, a flange may be formed between the first end portion of the coupling portion and the second end portion thereof, and the flange of the coupling portion may press the battery cover to seal the battery case.

A gasket may be disposed at a portion of the cross member, the portion being coupled to the coupling portion, and the flange of the coupling portion may press the gasket to seal the battery case.

The cross member may include a rib disposed therein, the rib may be disposed longitudinally inside the cross member and may include an upper end portion coupled to an upper portion of the cross member and a lower end portion formed to extend to a lower portion of the cross member, and a location allowing the rib to be coupled to the upper portion of the cross member may be a center portion of a portion allowing the cross member to be coupled to the seat.

The cross member may include a rib disposed therein, the rib may be disposed longitudinally inside the cross member and may include an upper end portion coupled to an upper portion of the cross member and a lower end portion formed to extend to a lower portion of the cross member, and a location allowing the rib to be coupled to the upper portion of the cross member may be a widthwise outermost portion of the cross member among portions allowing the upper portion of the cross member to meet the protrusion.

The cross member may include a rib disposed therein, the rib may be disposed longitudinally inside the cross member, and the rib may have opposite end portions respectively coupled to widthwise opposite outermost portions of the cross member among portions allowing an upper portion of the cross member to meet the protrusion.

The battery case may include a cooling plate disposed therein, the cooling plate may cover upper portions of the plurality of battery units and may allow a cooling medium to flow therethrough, and the cooling plate may include an exposure hole formed in a portion thereof corresponding to the cross member such that an upper surface of the cross member is exposed toward the vehicle floor through the exposure hole.

The cooling plate may be divided into a plurality of plate portions based on the cross member.

The plurality of plate portions may be connected to each other through a connection portion such that the cooling medium is exchanged between the plate portions.

The cross member may include a placement groove formed in a portion of the upper surface thereof, the portion corresponding to the connection portion, and the connection portion may be inserted into the placement groove.

The cross member may extend in a width direction of the vehicle, and the placement groove may be formed in a center portion of the cross member.

One side of the seat may be coupled to a seat cross member disposed on an upper portion of the vehicle floor, and the other side of the seat may be directly coupled to the cross member with the vehicle floor interposed therebetween.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a view showing a vehicle battery pack according to an exemplary embodiment of the present disclosure;

FIG. 2 is an enlarged view of a cross section taken along line A-A in FIG. 1;

FIG. 3 is a view showing the inside of a battery case shown in FIG. 1;

FIG. 4 is a view showing a state in which a battery unit is coupled to the battery case shown in FIG. 3;

FIG. 5 is an enlarged view of a protrusion of a cross member shown in FIG. 2;

FIG. 6 is a view showing a state in which a nut is coupled to the protrusion shown in FIG. 5;

FIG. 7 is a view showing the nut shown in FIG. 5;

FIG. 8 is a view showing a coupling portion shown in FIG. 5;

FIG. 9 is a view showing a cooling plate shown in FIG. 2;

FIG. 10 is a view showing a state in which a seat and a vehicle floor are coupled to the vehicle battery pack shown in FIG. 1; and

FIG. 11 is a view showing a cross section taken along line B-B in FIG. 10.

### DETAILED DESCRIPTION OF THE PREFERRED EMBODIMENTS

In describing the embodiments disclosed herein, when it is determined that a detailed description of publicly known techniques to which the disclosure pertains may obscure the gist of the present disclosure, the detailed description will be omitted. Furthermore, it should be understood that the accompanying drawings are merely illustrated to easily describe the embodiments disclosed in this specification, and therefore, the technical idea disclosed in this specification is not limited by the accompanying drawings. Furthermore, it should be noted that the accompanying drawings include all modifications, equivalents, and substitutes that fall within the spirit and technical scope of the present disclosure. The disclosure below is not intended to limit the present disclosure to a form described in the present disclosure or to a specific field, and it is contemplated that various alternative aspects and modifications to the present disclosure are possible, whether explicitly described or implied herein. It will be appreciated by those skilled in the art to which the present disclosure pertains that the form and details of the present disclosure may vary.

The present disclosure will be described with reference to specific embodiments. However, as will be appreciated by those skilled in the art to which the present disclosure pertains, various embodiments disclosed herein may be modified or otherwise implemented in various other ways without departing from the spirit and scope of the disclosure. Accordingly, the following description is to be considered as illustrative and is for the purpose of teaching those skilled in the art the manner of making and using various embodiments. It is to be understood that the forms of disclosure herein shown and described are to be taken as representative embodiments. Equivalent elements, materials, processes, or steps may be substituted for those representatively illustrated and described herein. Expressions such as “including”, “comprising”, “incorporating”, “consisting of”, “have”, and “is” used to describe and claim the present disclosure are intended to be construed in a non-exclusive manner, that is, to allow for items, components or elements not explicitly described also to be present. Reference to the singular is also to be construed to relate to the plural.

Furthermore, various embodiments disclosed herein are to be taken in the illustrative and explanatory sense and should not be construed as limiting the scope of the present disclosure. All references to joining (for example, attached, affixed, coupled, connected, and the like) are only used to aid the reader's understanding of the present disclosure and are not intended to limit the position, orientation, or use of a configuration and/or methods disclosed herein. Therefore, references to joining, if any, are to be construed broadly. Moreover, such references to joining do not necessarily infer that two or more elements are directly connected to each other. Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to any component, embodiment, variation, and/or modification, or the order or preference thereof. That is, while these expressions may be used to describe various components, the components are not limited by the corresponding expressions. These expressions are used only for the purpose of distinguishing one component from another.

Hereinafter, the suffixes “module”, “unit”, and “part” for components used in the following description are merely provided for facilitation of preparing this specification. Therefore, the suffixes themselves do not have significant meanings or roles.

When one component is referred to as being “connected” or “joined” to another component, the one component may be directly connected or joined to the other component, but it should be understood that other components may be present therebetween. On the other hand, when the one component is referred to as being “directly connected to” or “directly in contact with” the other component, it should be understood that no other components are present therebetween.

In addition, “unit” or “control unit” is only a term widely used in naming a controller for controlling a specific function of the vehicle, and does not mean a generic functional unit.

Examples of the device may include a communication device configured to communicate with other controllers or sensors to control the corresponding function, a non-transitory computer-readable medium configured to store an operating system or logic commands and input/output information, and one or more processors configured to perform determination, calculation, communication, and the like necessary for controlling the corresponding function.

Any number or components or a variety of components in any of the configurations described herein may be included within the disclosure described herein. The components may include any combination of the features described herein and may be disposed in any of the various configurations described herein. The structure and arrangement of the components of the present disclosure, as well as the concepts regarding the use and operation thereof may be applied not only to the specific embodiments discussed herein, but also to any number of embodiments in any combination. Embodiments including those having various features in various arrangements will be described below with reference to the drawings.

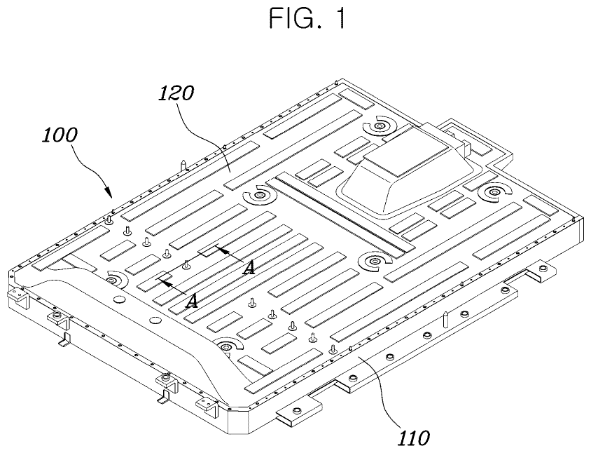

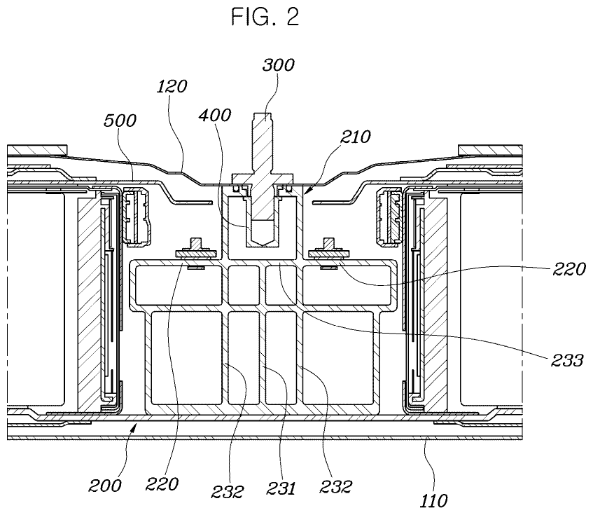

FIG. 1 is a view showing a vehicle battery pack according to an exemplary embodiment of the present disclosure, and FIG. 2 is an enlarged view of a cross section taken along line A-A of a cross member disposed in the vehicle battery pack shown in FIG. 1.

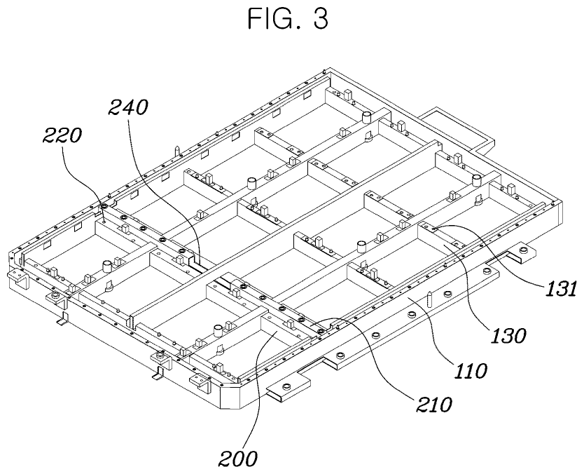

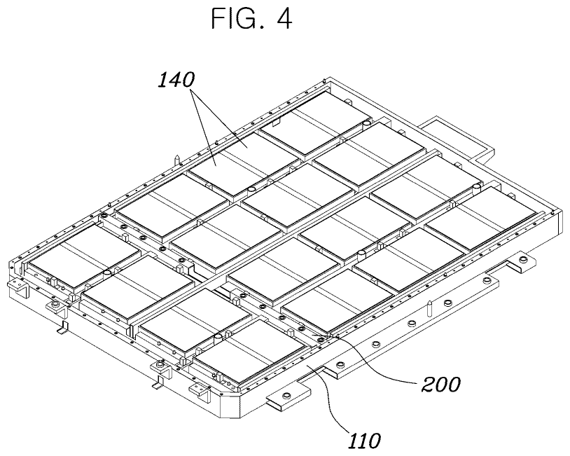

FIGS. 3 and 4 are views each showing the inside of a battery case from which a battery cover of the vehicle battery pack shown in FIG. 1 is removed.

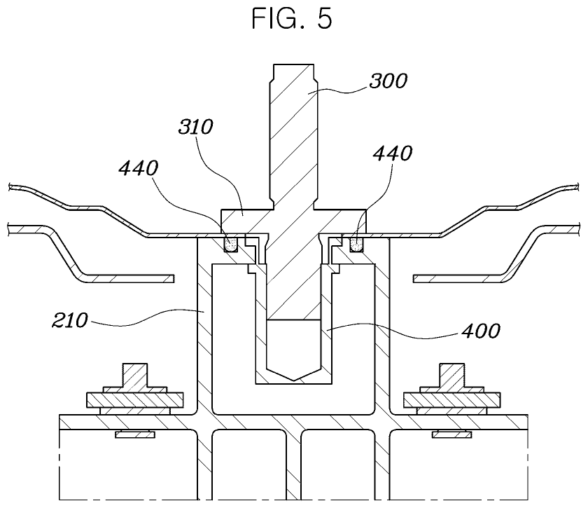

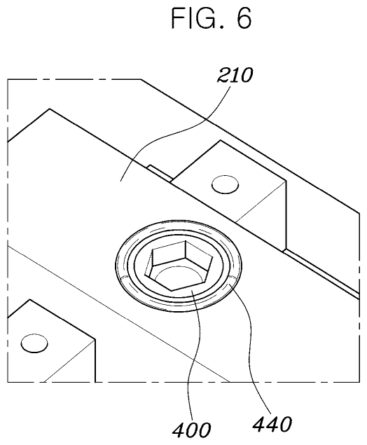

FIG. 5 is an enlarged view of a protrusion of the cross member shown in FIG. 2, and FIGS. 6 to 8 are views showing a nut coupled to the protrusion shown in FIG. 5 and a coupling portion coupled to the nut.

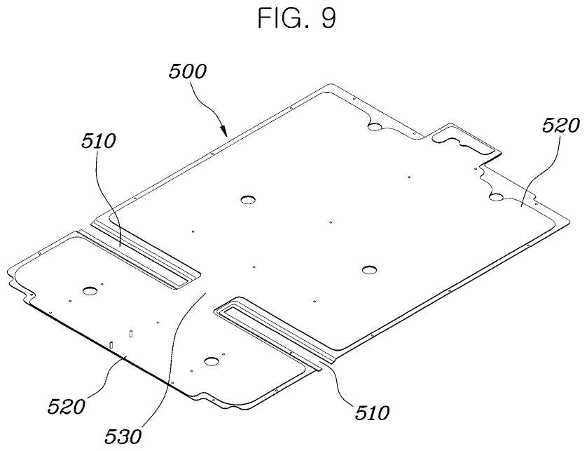

FIG. 9 is a view showing a cooling plate shown in FIG. 2.

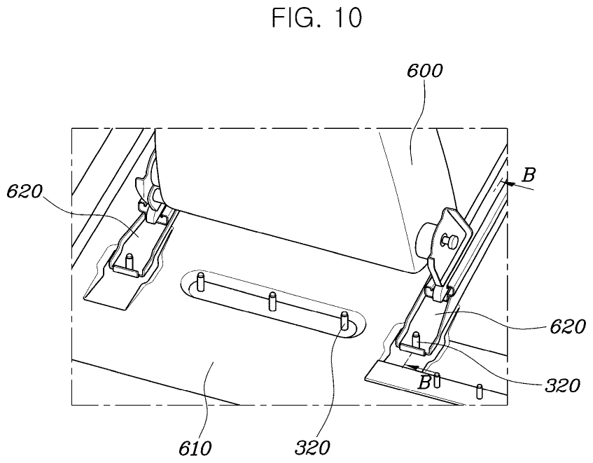

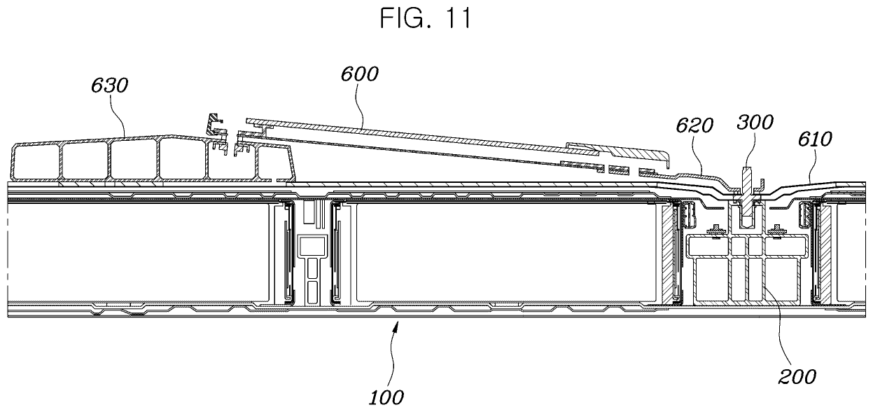

FIG. 10 is a view showing a state in which a seat and a vehicle floor are coupled to the vehicle battery pack shown in FIG. 1, and FIG. 11 is a view of a cross section in which the vehicle battery pack and the seat are coupled to each other, which is taken along line B-B in FIG. 10.

Hereinafter, various embodiments disclosed in the present specification will be described in detail with reference to the accompanying drawings. Wherever possible, the same reference numbers will be used throughout the drawings to refer to the same or like parts, and redundant descriptions thereof will be omitted.

Referring to FIGS. 1 to 4, a vehicle battery pack 100 according to an exemplary embodiment of the present disclosure includes a battery case 110 in which a cross member 200 and a plurality of battery units 140 are disposed, and a cooling plate 500 is disposed on the upper portions of the plurality of battery units 140. Furthermore, a battery cover 120 covers the cooling plate 500 and the cross member 200 to seal the battery case 110. The battery case 110 may be formed by molding an extrudable material or welding a press plate, and aluminum having a light weight and excellent formability may be used for the battery case 110. Aluminum having good thermal conductivity and excellent formability may be used for a cooling channel, and two pressed panels may be coupled to each other so as to form the cooling channel. The battery cover 120 may use aluminum or steel and may be formed by a press.

In the description of the present disclosure, as an example, the cooling channel is disposed between the battery unit 140 and the battery cover 120, but the present disclosure is not necessarily limited thereto. The cooling channel may also be disposed at the lower portion or the side portion of the battery unit 140.

The vehicle battery pack 100 of the present disclosure may remove the existing cross member disposed on the upper portion of the vehicle floor and connected to a vehicle seat and may replace some of the battery members disposed in the existing battery pack with the cross member 200 so as to directly couple the cross member 200 to a seat 600, thereby reducing the overall height and total weight of a vehicle. Through such a structural configuration, aerodynamic performance, vehicle stability, driving performance, fuel efficiency, braking performance, and the like are improved. That is, in the case of the existing vehicle, since a seat is coupled to a cross member disposed in the internal space of the upper portion of the floor, the height of the seat is increased by the height of the cross member. As a result, the height of the internal space of the vehicle needs to be increased by the height of the cross member. Accordingly, the overall height of the vehicle is inevitably increased, necessitating the use of more materials to manufacture a vehicle body, and leading to an increase in the overall weight and center of gravity of the vehicle. As a result, such a vehicle structure causes deterioration in dynamic performance.

According to the present disclosure, a cross member of a vehicle is formed to be integrated with a cross member of a battery pack, thereby reducing the weight of the vehicle. In particular, the present disclosure proposes an innovative method of disposing the integrated cross member 200 in the vehicle battery pack 100 so as to lower the overall height of the vehicle. In addition, despite the integration of the cross member, strength of coupling between a vehicle seat and a vehicle body is secured at an equivalent level. Furthermore, the seat 600, the vehicle body, the battery case 110, the cross member 200, and the like are firmly coupled to each other as a single mass body, thereby improving side collision performance compared to that of the related art.

The vehicle battery pack 100 is coupled to the lower portion of a vehicle floor 610, and the overall center of gravity of the vehicle is lowered when the cross member 200 located in the internal space of the upper portion of the vehicle floor 610 is moved to the inside of the vehicle battery pack 100. As a result, through such a structural configuration, it is possible not only to improve driving stability, cornering performance, braking performance, fuel efficiency, energy efficiency, and handling performance of the vehicle, but also to reduce the risk of vehicle rollover. In the present manner, various vehicle performance metrics may be improved.

The cross member 200 is disposed in the battery case 110 and is disposed to traverse the battery case 110. Here, the lower portion of the cross member 200 is coupled to the lower portion of the battery case 110, and the upper portion of the cross member 200 is directly coupled to the seat 600 with the vehicle floor 610 interposed therebetween while contacting the battery cover 120. To the present end, the vehicle floor 610 may include a hole configured for direct coupling between the cross member 200 and the seat 600 and formed in a portion thereof corresponding to a location at which the cross member 200 and the seat 600 are directly coupled to each other. Here, the upper portion of the cross member 200 may extend further upwards than the existing battery member so as to come into contact with the battery cover 120. For example, when the cross member 200 is directly coupled to the seat 600 with the vehicle floor 610 interposed therebetween, the seat 600, the vehicle floor 610, the battery cover 120, the cross member 200, and the battery case 110 are in close contact with each other and are reliably fixed to each other. Through the shape of the cross member 200, side collision performance may be improved compared to the related art.

Since the battery member 130 is disposed to strengthen rigidity of the vehicle battery pack 100, unlike the cross member 200, the upper portion of the battery member 130 does not need to extend upwards to contact the battery cover 120. Accordingly, the weight of the battery member 130 may be reduced, and the height of the vehicle battery pack 100 may be lowered.

A location at which the cross member 200 and the seat 600 are coupled to each other may be an upper portion of the cross member 200. Here, when the location is an upper center portion of the cross member 200, the load of the seat 600 is evenly distributed to the cross member 200, thereby improving durability and safety of the cross member 200.

Since the seat 600 is directly coupled to the cross member 200, accurate coupling therebetween is required at a specific location. To the present end, a protrusion 210 protruding upwards may be formed on the upper center portion of the cross member 200, and the protrusion 210 may be directly coupled to the seat 600 with the vehicle floor 610 interposed therebetween.

When the protrusion 210 is formed thereon, only the protrusion 210 contacts the battery cover 120. As a result, it is not necessary to form the cross member 200 higher overall, thereby reducing material costs and reducing the weight of the cross member 200. In addition, since a free space is formed on the side surface of the protrusion 210, a degree of freedom in designing the vehicle battery pack 100 is increased.

Furthermore, a fixing portion 220 to which the battery unit 140 is coupled is formed on the upper portion of the cross member 200. Since the fixing portion 220 is located to be lower than the protrusion 210, the protrusion 210 may support the load of the seat 600, and the battery unit 140 may be safely fixed to the fixing portion 220.

Referring to FIGS. 3 and 4, the battery member 130 configured for the battery unit 140 to be fixed thereto is disposed in the transverse direction or the longitudinal direction of the vehicle inside the battery case 110. Furthermore, since a mounting portion 131 is formed on the battery member 130, the battery unit 140 may be fixed to the mounting portion 131. The height of the mounting portion 131 and the height of the fixing portion 220 of the cross member 200 are the same. Accordingly, the battery unit 140 fixed to the cross member 200 may use the battery unit 140 including the same specifications as the battery unit 140 fixed to the battery member 130. That is, a previously used battery unit may be applied to the vehicle battery pack 100 of the present disclosure without changing the specifications of the previously used battery unit.

The cross member 200 may be disposed in the battery case 110 in the transverse direction or the longitudinal direction of the vehicle. In particular, when the cross member 200 is disposed in the transverse direction of the vehicle, as shown in FIG. 3, stability of the vehicle is improved in the event of side collision. Accordingly, the cross member 200 also plays an important role in reinforcing strength and rigidity of the vehicle. Meanwhile, it is also necessary to reduce the weight of the cross member 200 for efficiency of the vehicle. To the present end, in order to obtain balance between strength and weight reduction of the vehicle, the cross member 200 may be formed as an extruded material having an empty space formed therein. When the cross member 200 is formed as an extruded material, material utilization efficiency increases. For example, the cross member 200 may be formed to have a long length and may be continuously produced, thereby having an effect of reducing materials to be used and process costs.

However, when the empty space is formed in the cross member 200, the cross member 200 may be vulnerable to external impact. For example, ribs may be disposed in the cross member to reinforce rigidity and strength of the cross member 200 and to prevent deformation and distortion thereof. Although the ribs may be disposed at various locations inside the cross member 200, the ribs need to be disposed at the optimal location in consideration of cost and weight.

For example, as shown in FIG. 2, a center portion rib 231 is disposed in the longitudinal direction of the cross member 200, and the upper portion of the center portion rib 231 is coupled to the center portion of the upper portion of the cross member 200 among the portions at which the cross member 200 and the seat 600 are coupled to each other, and the lower portion of the center portion rib 231 extends to the lower portion of the cross member 200. The center portion rib 231 supports the center portion of the cross member 200, to which the largest load of the seat 600 is applied, thereby supporting the load applied from the seat 600 and reinforcing rigidity against side collision.

As another example, the upper portion of a side rib 232 is coupled to a portion at which the protrusion 210 and the upper portion of the cross member 200 are connected to each other, and the lower portion thereof extends to the lower portion of the cross member 200. For example, the side rib 232 supports the load from a connection portion at which the load from the protrusion 210 is concentrated, thereby preventing bending of the protrusion and reinforcing rigidity against side collision.

As another example, when an upper rib 233 is connected to a portion at which the protrusion 210 and the upper portion of the cross member 200 are connected to each other and extends, it is possible to prevent bending of the protrusion 210 and reinforce rigidity against side collision.

Some or all of the ribs described above may be formed inside the cross member 200 as necessary to achieve balance between strength and weight.

The cross member 200 inside the vehicle battery pack 100 of the present disclosure is directly coupled to the seat 600. To the present end, a nut 400 is coupled to the upper portion of the cross member 200, a lower portion 330 of a coupling portion 300 is fixed to the nut 400, and an upper portion 320 of the coupling portion 300 is disposed to penetrate the vehicle floor 610 so as to be coupled to the seat 600. The nut 400 may be coupled to the cross member 200 by a press-fitting method or a riveting method.

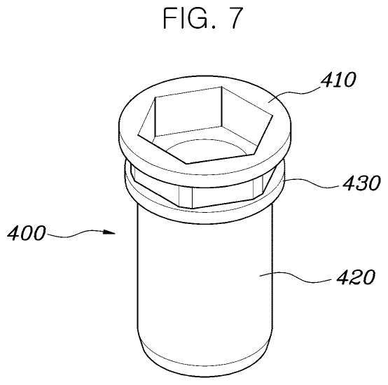

Specifically, referring to the nut 400 shown in FIGS. 6 and 7, in the case of the press-fitting method, the nut 400 includes a nut head 410 and a fixed groove 430. Here, the external diameter of the nut head 410 is formed to be larger than the external diameter of the fixed groove 430, and a nut hole for insertion of the nut 400 is formed in the cross member 200. The internal diameter of the nut hole is larger than the external diameter of the fixed groove 430 and is smaller than the external diameter of the nut head 410. When the nut 400 is inserted into the nut hole of the cross member 200, the nut head 410 is supported on the upper portion of the cross member 200. For example, when pressure is applied to the nut head 410, the nut head 410 presses the cross member 200 downwards, and a part of the cross member 200 is pushed into a space formed between the nut head 410 and the fixed groove 430, coupling the nut 400 to the cross member 200.

In the case of the riveting method, the nut 400 includes the nut head 410 and a nut shank 420. The external diameter of the nut head 410 is larger than the external diameter of the nut shank 420. A nut hole is formed in the cross member 200 for insertion of the nut 400, and the internal diameter of the nut hole is larger than the external diameter of the nut shank 420 and is smaller than the external diameter of the nut head 410. When the nut 400 is inserted into the nut hole formed in the cross member 200, the nut head 410 is supported by the upper portion of the cross member 200. For example, the location of the nut head 410 is fixed using a coupling tool, and the nut shank 420 is moved upwards. Thereafter, the nut shank 420 is pushed upwards, and the fixing groove 430 is formed on the lower surface of the upper portion of the cross member 200, coupling the nut to the cross member 200.

In addition, in order to prevent rotation of the nut 400 in the longitudinal direction of the nut 400 in the cross member 200, the external wall of the lower portion of the nut head 410 and the internal wall of the nut hole for insertion of the nut 400 in the cross member 200 are formed to have the same polygonal shape, and the nut 400 is inserted into the internal wall of the nut hole, preventing rotation of the nut 400.

The coupling portion 300 is formed at the lower portion of the seat 600 and extends from the lower portion of the seat 600 to penetrate the vehicle floor 610 and to be coupled to the nut 400.

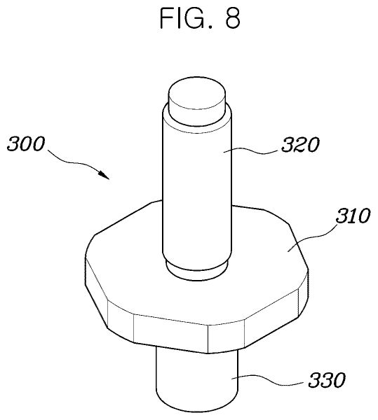

In addition, as shown in FIG. 8, screw threads are formed on the upper portion 320 of the coupling portion and the lower portion 330 of the coupling portion. Here, the lower portion 330 of the coupling portion may be coupled to the nut 400, and the upper portion 320 of the coupling portion may be coupled to the seat 600. For example, since the upper portion 320 of the coupling portion coupled to the cross member 200 extends through the vehicle floor 610, an assembly guide pin may be removed from the seat 600, thereby reducing processes, material costs, and weight. In addition, through simultaneous coupling between the vehicle battery pack 100, the vehicle floor 610, and the seat 600, noise, vibration, and harshness (NVH) performance of the vehicle may be improved.

Meanwhile, the vehicle battery pack 100 needs to be sealed to protect the battery unit 140 from the external environment or impact, to manage stability, temperature, and heat inside the vehicle battery pack 100, and to improve electrical stability. To the present end, a flange 310 is formed between the upper and lower end portions of the coupling portion 300, and the flange 310 is supported on the upper portion of the battery cover 120. Here, when the battery cover 120 is pressed downwards, the battery case 110 may be sealed by the battery cover 120.

In addition, as shown in FIG. 6, a gasket 440 may be disposed around a portion at which the nut head 410 is disposed in the cross member 200 so as to strengthen sealing force of the vehicle battery pack 100. For example, a gasket groove configured for the gasket 440 to be disposed therein may be formed in the cross member 200, and the gasket 440 may be inserted into the gasket groove. Through this structural configuration, the gasket 440 may be fixed in the correct position, sealing performance and lifespan of the gasket 440 may be extended, and installation efficiency of the gasket 440 may be increased.

The cooling plate 500 may be disposed in the vehicle battery pack 100 to optimize performance of a plurality of battery units 140 and to extend the lifespan thereof. The cooling plate 500 may be disposed on the upper or lower portion of the plurality of battery units 140, and a cooling channel through which a cooling medium flows may be formed in the cooling plate 500.

As described above, the vehicle battery pack 100 of the present disclosure includes the cross member 200 directly coupled to the seat 600. Accordingly, when the cooling plate 500 is disposed on the upper portion of the plurality of battery units 140, an exposure hole 510 is formed in the cooling plate 500 at a portion corresponding to the cross member 200, and the cross member 200 is coupled to the seat 600 through the exposure hole 510.

Additionally, since the cooling plate 500 needs to be formed continuously without any interruption in the cooling channel for the flow of the cooling medium, the cooling plate 500 is divided into a plurality of plate portions 520 based on the cross member 200, and the plate portions 520 are connected to each other through a connection portion 530 such that cooling medium is exchanged between the respective plate portions 520.

Since the connection portion 530 needs to be protected from impact to secure stable flow of the cooling medium, a placement groove 240 is formed in the upper portion of the cross member 200 and is located at a portion corresponding to the connection portion 530. When the connection portion 530 is inserted into the placement groove 240, load from a seat or the like is not applied to the cooling plate 500. In addition, since the location of the cooling plate 500 is lowered by the amount of insertion of the connection portion 530 into the placement groove 240, the overall height of the vehicle battery pack 100 is lowered. Accordingly, a distance between the battery case 110 of the vehicle battery pack 100 disposed under the vehicle floor 610 and the ground increases, thereby improving stability of the vehicle battery pack 100.

When the cross member 200 is disposed in the width direction of the vehicle and the placement groove 240 is formed in the center portion of the cross member 200, the seat 600 is connected to the opposite end portions of the cross member 200. Accordingly, a load of the seat 600 is not directly applied to the placement groove 240, efficiently maintaining rigidity and strength of the cross member 200.

In addition, when the heights of the plurality of cooling plate portions 520 and the connection portion 530 are formed to be the same, a cooling medium may smoothly flow through the cooling plate portions 520 and the connection portion 530. To this end, when the height of the lower end portion of the placement groove 240 in the cross member 200 is formed to be the same as the height of the battery unit 140, the entire cooling plate 500 may be stably disposed with the same height overall.

Since the vehicle battery pack 100 is coupled to the lower portion of the vehicle floor 610, damage, vibration, noise, and the like may be caused by friction generated between the vehicle battery pack 100 and the vehicle floor 610. To prevent such problems, a vibration-and-shock-absorbing material, a sliding-and-friction-preventing coating, or a friction-preventing tape may be disposed on the upper portion of the battery cover 120.

Some of the plurality of coupling portions 300 coupled to the cross member 200 are coupled to the vehicle floor 610, and the remaining coupling portions 300 are coupled to the seat 600. When the coupling portion 300 is coupled to the vehicle floor 610, the upper portion 320 of the coupling portion 300 is disposed to penetrate the vehicle floor 610, and a fixing nut is coupled to the upper portion 320 of the coupling portion 300, fixing the coupling portion 300 to the vehicle floor 610.

The seat 600 is coupled to the opposite end portions of the cross member 200 with the center portion of the cross member 200 formed between the opposite end portions.

Referring to FIG. 10, among the plurality of coupling portions 300 coupled to one end side of the cross member 200, the upper portions 320 of the coupling portions 300 located at the center portion of the cross member 200 are coupled to the floor 610 of the vehicle, and the remaining upper portions 320 of the coupling portions 300 are coupled to the seat 600.

A bracket 620 configured to allow movement of the seat 600 may be disposed on the upper portion 320 of the coupling portion 300 coupled to the seat 600. The bracket 620 may adjust the location of the seat and may add various functions. Furthermore, the bracket 620 may allow the same seat to be applied to a plurality of vehicles without change, thereby reducing costs.

One side and the other side of the seat 600 may be respectively coupled to a seat cross member 630 and the cross member 200 disposed in the vehicle battery pack 100. In particular, the seat 600 is basically formed to include an inclination angle such that the rear side of the seat 600, which is connected to a seatback, is located to be lower than the front side of the seat 600 for convenience and stability. Therefore, as shown in FIG. 11, when the front side of the seat 600 is coupled to the seat cross member 630 and the rear side is coupled to the cross member 200, more space in the height direction may be secured while the basic inclination angle of the seat 600 is maintained.

As is apparent from the above description, the present disclosure provides a vehicle battery pack configured to dispose, in the vehicle battery pack, a cross member disposed on the upper portion of the vehicle floor and coupled to a vehicle seat, and to directly couple the vehicle seat to the cross member disposed in the vehicle battery pack, thereby having an effect of not only lowering the overall height and weight of a vehicle but also improving collision performance of the vehicle. As a result, overall vehicle performance may be improved through such a structural configuration.

Furthermore, NVH performance of a vehicle may be improved by simultaneously coupling a battery, a seat, and a vehicle body to each other.

The effects of the present disclosure are not limited to the above-mentioned effects, and other effects not mentioned herein will be clearly understood by those skilled in the art to which the present disclosure pertains from the detailed description of the embodiments.

Although the preferred embodiments of the present disclosure have been disclosed for illustrative purposes, those skilled in the art will appreciate that various modifications, additions, and substitutions are possible, without departing from the scope and spirit of the disclosure as disclosed in the accompanying claims.

What is claimed is:

1. A vehicle battery pack comprising:
a battery case coupled to a lower portion of a vehicle floor, the battery case including a plurality of battery units disposed therein; and
a cross member disposed in the battery case and traversing the battery case, the cross member being disposed between the plurality of battery units, the cross member including a lower end portion coupled to a lower end portion of the battery case and an upper end portion formed to extend to an upper end portion of the battery case, the cross member being directly coupled to a seat disposed in an internal space of a vehicle by penetrating the vehicle floor.

2. The vehicle battery pack of claim 1, wherein the cross member is disposed in a transverse direction of the vehicle inside the battery case.

3. The vehicle battery pack of claim 1, wherein the cross member includes an upper center portion directly coupled to the seat with the vehicle floor interposed therebetween.

4. The vehicle battery pack of claim 1, wherein the cross member includes a protrusion protruding upwards from an upper center portion thereof, and the protrusion is directly coupled to the seat with the vehicle floor interposed therebetween.

5. The vehicle battery pack of claim 4, wherein the cross member includes a fixing portion formed at an upper side portion thereof, the fixing portion being formed lower than the protrusion, and the plurality of battery units are fixed to the fixing portion.

6. The vehicle battery pack of claim 5, wherein the battery case includes a battery member disposed therein, the battery member comprising a mounting portion configured to fix the plurality of battery units, and a height of the mounting portion is equal to a height of the fixing portion.

7. The vehicle battery pack of claim 1, wherein the cross member includes a nut disposed in an upper portion thereof, the nut is coupled to a first end portion of a coupling portion, and a second end portion of the coupling portion is disposed to penetrate the vehicle floor to be coupled to the seat.

8. The vehicle battery pack of claim 7, wherein the coupling portion extends from a lower portion of the seat and is disposed to penetrate the vehicle floor so as to be coupled to the nut.

9. The vehicle battery pack of claim 7, wherein the battery case includes an upper surface sealed by a battery cover, a flange is formed between the first end portion of the coupling portion and the second end portion thereof, and the flange of the coupling portion presses the battery cover to seal the battery case.

10. The vehicle battery pack of claim 9, wherein a gasket is disposed at a portion of the cross member, the portion being coupled to the coupling portion, and the flange of the coupling portion presses the gasket to seal the battery case.

11. The vehicle battery pack of claim 1, wherein the cross member includes a rib disposed therein, the rib is disposed longitudinally inside the cross member and includes an upper end portion coupled to an upper portion of the cross member and a lower end portion formed to extend to a lower portion of the cross member, and a location allowing the rib to be coupled to the upper portion of the cross member is a center portion of a portion allowing the cross member to be coupled to the seat.

12. The vehicle battery pack of claim 4, wherein the cross member includes a rib disposed therein, the rib is disposed longitudinally inside the cross member and includes an upper end portion coupled to an upper portion of the cross member and a lower end portion formed to extend to a lower portion of the cross member, and a location allowing the rib to be coupled to the upper portion of the cross member is a widthwise outermost portion of the cross member among portions allowing the upper portion of the cross member to meet the protrusion.

13. The vehicle battery pack of claim 4, wherein the cross member includes a rib disposed therein, the rib is disposed longitudinally inside the cross member, and the rib has opposite end portions respectively coupled to widthwise opposite outermost portions of the cross member among portions allowing an upper portion of the cross member to meet the protrusion.

14. The vehicle battery pack of claim 1, wherein the battery case includes a cooling plate disposed therein, the cooling plate being configured to cover upper portions of the plurality of battery units and to allow a cooling medium to flow therethrough, and the cooling plate includes an exposure hole formed in a portion thereof corresponding to the cross member such that an upper surface of the cross member is exposed toward the vehicle floor through the exposure hole.

15. The vehicle battery pack of claim 14, wherein the cooling plate is divided into a plurality of plate portions based on the cross member.

16. The vehicle battery pack of claim 15, wherein the plurality of plate portions are connected to each other through a connection portion so that the cooling medium is exchanged between the plate portions.

17. The vehicle battery pack of claim 16, wherein the cross member includes a placement groove formed in a portion of the upper surface thereof, the portion corresponding to the connection portion, and the connection portion is inserted into the placement groove.

18. The vehicle battery pack of claim 17, wherein the cross member extends in a width direction of the vehicle, and the placement groove is formed in a center portion of the cross member.

19. The vehicle battery pack of claim 1, wherein a first side of the seat is coupled to a seat cross member disposed on an upper portion of the vehicle floor, and a second side of the seat is directly coupled to the cross member with the vehicle floor interposed therebetween.
